(19) United States
(12) Patent Application Publication
(10) Pub. No.: US 2011/0191723 A1
(43) Pub. Date: Aug. 4, 2011

(54) METHOD OF CONTROLLING A CURSOR ON A MULTI-TOUCH SCREEN BY USING ON-DEVICE OPERATION

(75) Inventors: DENG-JING WU, TAINAN COUNTY 741 (TW); HSUEH-WEI YANG, HSINCHU COUNTY 302 (TW); YU-JEN TSAI, HSINCHU CITY 300 (TW); HSIAO-HUA TSAI, HSINCHU COUNTY 302 (TW)

(73) Assignee: ELAN MICROELECTRONICS CORPORATION, HSINCHU 300 (TW)

(21) Appl. No.: 12/839,607

(22) Filed: Jul. 20, 2010

Related U.S. Application Data
(60) Provisional application No. 61/227,505, filed on Jul. 22, 2009.

(51) Int. Cl. G06F 3/048

(52) U.S. Cl. 715/856

(57) ABSTRACT

A method of controlling a cursor on a screen by using a touch device includes changing a display coordinate set of the cursor on the screen representative of an object according to a relative coordinate set with respect to movement of the object on the touch device, hiding the cursor from the screen when the object leaves the touch device for a duration in excess of a predetermined time, and when the cursor is not displayed on the screen and an object touches the touch device, computing an initial display coordinate set of the cursor on the screen according to an absolute coordinate set of the object on the touch device and a resolution ratio between the touch device and the screen. With this method, the cursor on the screen can be intuitively operated by using the touch device.

### CROSS REFERENCE TO RELATED APPLICATIONS

This application claims the benefit of U.S. Provisional Application No. 61/227,505, filed on Jul. 22, 2009.

### FIELD OF THE INVENTION

The present invention is related generally to a touch device and, more particularly, to a method of controlling a cursor on a screen by using a touch device.

### BACKGROUND OF THE INVENTION

The developing touch technology has realized, in addition to the conventional small-size touch screens for portable devices, the operating environments (operating systems) supporting multi-touch screens, such as Windows 7 from Microsoft and iPhone OS from Apple, which allow large-size touch screens to be used for stationary devices and thereby allow users' intuitive operation through the touch screens. However, there are shortcomings related to large-size touch screens, such as the high costs of the hardware and the operation requests users to stay before the screens. As to touch devices other than touch screens, the operation by users' fingers is not conducted directly on their screens, so contact of the fingers to the touch devices is unable to directly control cursor displayed on the screens. Due to the resolution difference between a touch device and a screen, a coordinate set of an object on the touch device can not be directly reflected on the screen.

### SUMMARY OF THE INVENTION

An object of the present invention is to provide a method of controlling a cursor on a screen by using a touch device.

According to the present invention, a method of controlling a cursor on a screen by using a touch device involves changing a display coordinate set of the cursor representative of an object on the screen according to a relative coordinate set with respect to movement of the object on the touch device, hiding the cursor from the screen when the object leaves the touch device for a duration longer than a predetermined time, and when the cursor is not displayed on the screen and an object touches the touch device, computing an initial display coordinate set of the cursor on the screen according to an absolute coordinate set of the object on the touch device and a resolution ratio between the touch device and the screen.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a flowchart of an embodiment according to the present invention;

FIG. 2 is a schematic drawing illustrating determination of an initial display coordinate set of a cursor on a screen according to a resolution ratio between a touch device and a screen; and

FIG. 3 is a schematic drawing illustrating determination of initial display coordinate sets of cursors on a screen under multi-finger operation according to the resolution ratio between a touch device and a screen.

### DETAILED DESCRIPTION OF THE INVENTION

A touch device adoptable for performing a control method of the present invention may be one installed on a notebook computer or an external peripheral device. In the event that the touch device is the latter that communicates with a controlled device through wireless transmission, a user can operate the touch device without being tied up before a screen. When a user operates the touch device, the screen displays a cursor representative of the user's finger or an object on the touch device and the touch device then sends information related to the cursor to a controlled device in a format supported by the controlled device. Since there are problems related to multi-finger operation of the touch device such as interlaced cursors or cursors without intuitive correspondence, the present invention provides a method that counts the duration where an object leaves a touch device so as to automatically hide a cursor representative of the object from a screen when the duration is longer than a predetermined time, and to compute an initial display coordinate set of the cursor on the screen according to an absolute coordinate set of the object on the touch device and a resolution ratio between the touch device and the screen when the object contacts the touch device again after the leaving duration.

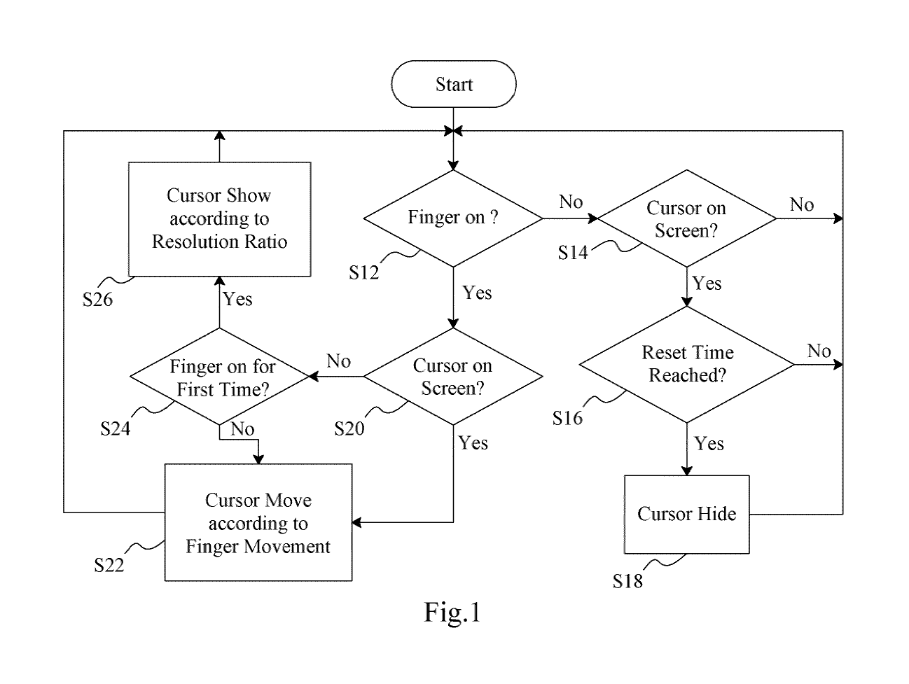

FIG. 1 is a flowchart of a method according to the present invention. Step S12 detects whether or not a touch device is touched. If not, the process goes to step S14 to identify whether there is a cursor representative of the object displayed on a screen. If yes, step S16 is performed to check whether the duration where the object leaves the touch device is in excess of a predetermined time. If yes, the process is continued by step S18 to automatically hide the cursor representative of the object. If step S12 identifies that the touch device is touched, step S20 is then performed to identify whether a cursor is shown on the screen. If yes, the process goes to step S22 to change a display coordinate set of the cursor according to a relative coordinate set with respect to movement of the object on the touch device. If step S20 identifies that there is no cursor shown on the screen, step S24 is performed to check whether there is other information about the cursor and identify whether this is a touch on the touch device for first time. If yes, the process goes to step S26 to compute an initial display coordinate set of the cursor on the screen according to the resolution ratio between the touch device and the screen. Otherwise, step S22 instead of step S26 is performed to change the display coordinate set of the cursor. In some embodiments, step S18 further comprises deleting all information about the cursor, including the display coordinate set, so as to following step S20 where it is determined that there is no cursor shown on the screen, directly perform step S26 to determine the initial display coordinate set of the cursor on the screen without performing the determination of step S24.

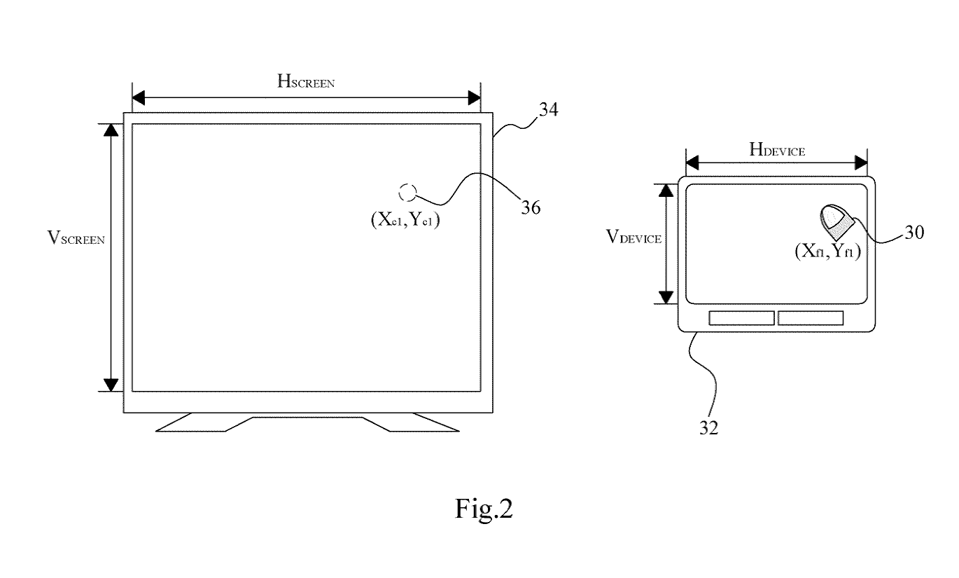

FIG. 2 is a schematic drawing showing determination of an initial display coordinate set of a cursor on a screen according to the resolution ratio between a touch device and the screen. When an object 30 touches a touch device 32 for first time, step S28 shown in FIG. 1 is performed to compute the initial display coordinate set of a cursor 36 on the screen 34 according to the resolution ratio between the touch device 32 and the screen 34 as

$${X}_{c 1} = \frac{{H}_{SCREEN}}{{H}_{DEVICE}} \times {X}_{f 1} , \\ {Y}_{c 1} = \frac{{V}_{SCREEN}}{{V}_{DEVICE}} \times {Y}_{f 1} . \qquad [ Eq \text{-} 1 ]$$

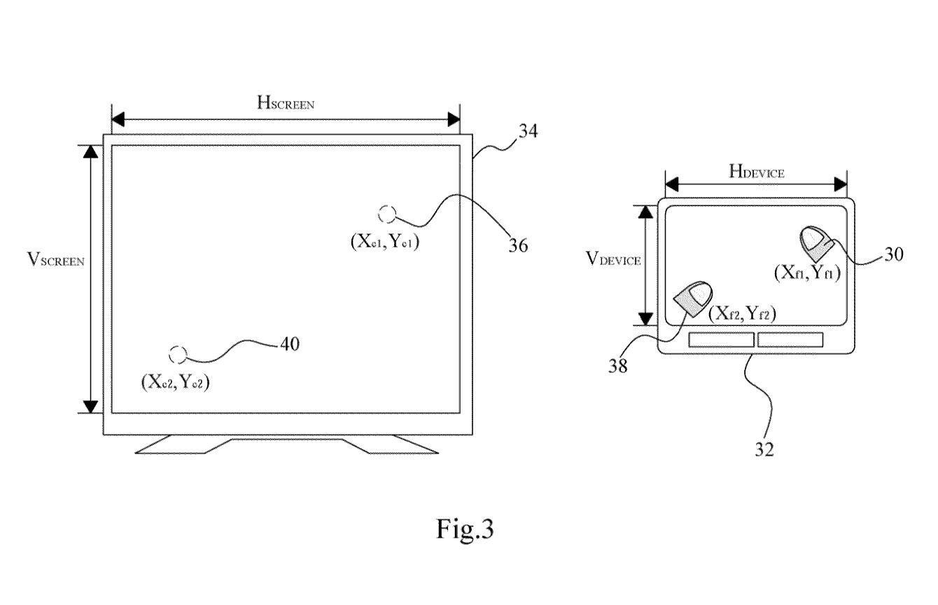

FIG. 3 is a schematic drawing showing determination of initial display coordinate sets of cursors on a screen under multi-finger operation according to the resolution ratio between a touch device and the screen. When a user uses multiple objects to operate the touch device 32, in addition to that of the object 30 shown in FIG. 2, the initial display coordinate set of a cursor 40 representative of another object 38 on the screen 34 is also computed according to the resolution ratio between the touch device 32 and the screen 34 as

$${X}_{c 2} = \frac{{H}_{SCREEN}}{{H}_{DEVICE}} \times {X}_{f 2} , \\ {Y}_{c 2} = \frac{{V}_{SCREEN}}{{V}_{DEVICE}} \times {Y}_{f 2} . \qquad [ Eq \text{-} 2 ]$$

After the foregoing computation of the coordinate sets, if the user slides the object 30 or 38 on the touch device 32, the cursor 36 or 40 on the screen 34 will have its display coordinate set on the screen 34 changed according to the relative coordinate set with respect to the movement of the object 30 or 38 on the touch device 32. When the object 30 or 38 leaves the touch device 32 no longer than the predetermined time, the last coordinate set of the cursor 36 or 40 is preserved so that the user is allowed to make the cursor 36 or 40 on the screen 34 perform long-distance movement of the display coordinate set or conduct other operation by repeatedly changing the relative coordinate set.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A method of controlling a cursor on a screen by using a touch device, the method comprising the steps of:
(a) changing a display coordinate set of the cursor on the screen representative of an object according to a relative coordinate set with respect to movement of the object on the touch device;
(b) hiding the cursor from the screen when the object leaves the touch device for a duration in excess of a predetermined time; and
(c) when the cursor is not displayed on the screen and the object touches the touch device, computing an initial display coordinate set of the cursor on the screen according to an absolute coordinate set of the object on the touch device and a resolution ratio between the touch device and the screen.

2. The method of claim 1, wherein the step (c) comprises the step of deleting all information about the cursor, including the display coordinate set.

3. The method of claim 1, further comprising preserving the display coordinate set of the cursor when the object temporarily leaves the touch device for a duration not in excess of the predetermined time.

4. The method of claim 1, further comprising preserving all information about the cursor, including the display coordinate set, when the object temporarily leaves the touch device for a duration not in excess of the predetermined time.
